(19) United States
(12) Patent Application Publication
(10) Pub. No.: US 2021/0365614 A1
(43) Pub. Date: Nov. 25, 2021

(54) MACHINE LEARNING BASED DESIGN FRAMEWORK

(71) Applicant: International Business Machines Corporation, Armonk, NY (US)

(72) Inventors: Wei Sun, Tarrytown, NY (US); Brian Leo Quanz, Yorktown Heights, NY (US); Ajay Ashok Deshpande, Pleasantville, NY (US); Jae-Eun Park, Wappingers Falls, NY (US)

(21) Appl. No.: 16/881,239

(22) Filed: May 22, 2020

(51) Int. Cl. G06F 30/27; G06N 3/04; G06N 3/08; G06Q 30/02; G06Q 10/10; G06Q 10/06; G06Q 50/04

(52) U.S. Cl. CPC G06F 30/27; G06N 3/0454; G06N 3/088; G06F 2111/16; G06Q 10/10; G06Q 10/06375; G06Q 50/04; G06Q 30/0201

(57) ABSTRACT

A computer-implemented method for a machine learning based design framework includes receiving input data, generating a design proposal based on the input data using a machine learning model, receiving feedback for the design proposal from a designated reviewer of the design proposal, updating a user preference profile associated with the designated reviewer using data generated by a different machine learning model based on the feedback for the design proposal, updating the design proposal to replace the candidate design with a new candidate design based on the user preference profile, and generating a final design based on the design proposal. Various other methods, systems, and computer-readable media are also disclosed.

### BACKGROUND

The present invention relates in general to programmable computing systems and, more specifically, programmable computing systems configured to implement a machine learning based design framework for package design.

Product packaging design is an integral part of product and brand identity, which influences consumer experience, buying decisions, and loyalty. Packaging designs can offer unique appeal in terms of aesthetics, utility, creativity, trendiness, and brand impression while keeping costs and environmental impacts at bay. Package designs can also impact consumer impressions. For instance, packaging designs can increase sales of a product or increase consumer reach.

### SUMMARY

According to one or more embodiments of the present invention, a method for a machine learning based design framework includes receiving input data. A design proposal is generated based on the input data using a machine learning model. The design proposal includes one or more candidate designs. Feedback for the design proposal is received from a designated reviewer of the design proposal. A user preference profile associated with the designated reviewer is updated using data generated by a different machine learning model based on the feedback for the design proposal. The design proposal is updated to replace one of the one or more candidate designs with a new candidate design based on the user preference profile associated with the designated reviewer. A final design is generated based on the design proposal.

The technical solutions can also be implemented by a system, a computer program product, an apparatus, a machine, a device, or in other practical applications in one or more embodiments of the present invention.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic illustration of a computerized environment for a machine learning based design framework for package design in accordance with one or more embodiments of the present invention;

FIG. 2 is a block diagram representing an example design process executed by a machine learning based design framework in accordance with one or more embodiments of the present invention;

FIG. 3 is a schematic hybrid data flow/block diagram illustrating a package design data flow using a machine learning based design framework in accordance with one or more embodiments of the present invention;

FIG. 4 is a schematic hybrid data flow/block diagram illustrating a data flow for interactive preference learning using a machine learning based design framework in accordance with one or more embodiments of the present invention;

FIG. 5 is an illustrative example for design space generation by a machine learning based design framework in accordance with one or more embodiments of the present invention;

FIG. 6 is an illustrative example for rapid prototyping of package designs by a machine learning based design framework in accordance with one or more embodiments of the present invention;

FIG. 7 is an illustrative example for rapid prototyping of package designs by a machine learning based design framework in accordance with one or more embodiments of the present invention;

FIG. 8 is an illustrative example for style morphing by a machine learning based design framework in accordance with one or more embodiments of the present invention;

FIG. 9 is an illustrative example for shape fine-tuning with shape morphing by a machine learning based design framework in accordance with one or more embodiments of the present invention;

FIG. 10 is a process flow diagram of an illustrative method for package design generation using a machine learning based design framework for package design in accordance with one or more embodiments of the present invention;

FIG. 11 is a process flow diagram of an illustrative method for interactive preference learning in a machine learning based design framework for package design in accordance with one or more embodiments of the present invention; and

FIG. 12 is a computer system in accordance with one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Exemplary embodiments of the present invention relate to, among other things, devices, systems, computer-implemented methods, and computer-readable media configured and arranged to implement a machine learning (ML) based design framework for package design generation.

Conventional packaging design processes are time and resource consuming. In some examples, known approaches to generating package designs involve a lengthy design process based on communication between multiple groups or departments, such as marketers, product developers, vendors, and designers. Such groups often work in silos, which can contribute to delays or miscommunications. Additionally, the iterative manual design refinements communicated through the communications can be tedious and slow. Design evaluations performed on multiple real trial prototypes with consumer testing can also increase the expense and time required to arrive at a final design. Additionally, conventional packaging workflows do not have tools to estimate how a design would perform along different dimensions, such as sales, appeal to customer segments, cost, etc.

In a known design process, a non-designer who develops ideas must rely on an expert designer to create visualizations. The non-designer is often not able to make quick design changes to a proposed design idea. An expert designer can get trapped in past design biases or blind spots, and can miss potential blockbuster new designs. The systems and methods described herein are directed to a design framework that uses data and AI tools for rapid generation of realistic visualizations of package designs, which can increase cost and time efficiency during the package design process.

In exemplary embodiments of the present invention, the systems and computer-implemented methods described herein can rapidly generate realistic visualizations of package designs using ML models and a streamlined workflow process to increase time and cost efficiency in the package design process. Conventional design processes rely on expert designers to create renderings of package designs using tools that require training and experience. Non-designers cannot easily generate a design or make quick alterations to designs without a working knowledge of the design tools. The systems and methods described herein are directed at a co-creative design framework that utilizes machine learning techniques to assist users to rapidly produce packaging designs. Additionally, the system learns about preferences and current design goals of the different users involved in the design process through interactive and/or iterative received feedback from the users as they interact with the system throughout the design process.

Although described within the context of prototyping package design, the systems and methods described herein are applicable to any device, scenario, and/or field that utilizes a design process, which requires iterations of design generation and refinement and/or requires input and/or approval from multiple groups or individuals to generate a finalized design.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units described in this specification have been labeled as modules. Embodiments of the present invention apply to a wide variety of module implementations. For example, a module can be implemented as a hardware circuit configured to include custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. A module can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, include the module and achieve the stated purpose for the module.

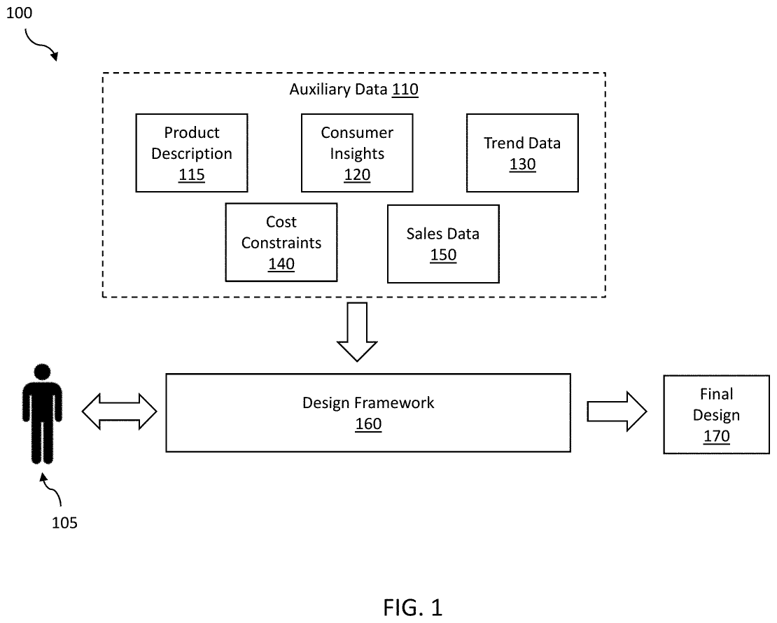

FIG. 1 is a schematic illustration of a computerized environment 100 for a ML based design framework for package design in accordance with one or more embodiments of the present invention. In some embodiments of the invention, a user 105 can provide input data to a design framework 160. Examples of input data include inspiration data for a design proposal such as images, audio files, keywords, an existing design, a video, a report outlining parameters or constraints for the design proposal, or the like. The design framework 160 can include a user interface or AI-driven tool configured to receive input data from the user 105. The design framework 160 can generate, using one or more ML models and techniques, a design proposal based on the input data, any identified constraints or conditions, and/or auxiliary data 110 received and/or accessed by the design framework 160. Examples of auxiliary data 110 include product descriptions 115, consumer insights 120, trend data 130, cost constraints 140, and/or historical sales data 150. The auxiliary data 110 can be historic data stored and maintained by the design framework 160 or can be data obtained through other means, such as third parties or scraping data from the Internet. The design proposal can be presented to the user 105. Based on feedback received from the user 105 (or other individuals involved in the design process, such as designated reviewers), the design proposal is updated or modified. In some examples, upon receiving approval from the user 105 (and/or other designated reviewers of the design process), the final design 170 is generated.

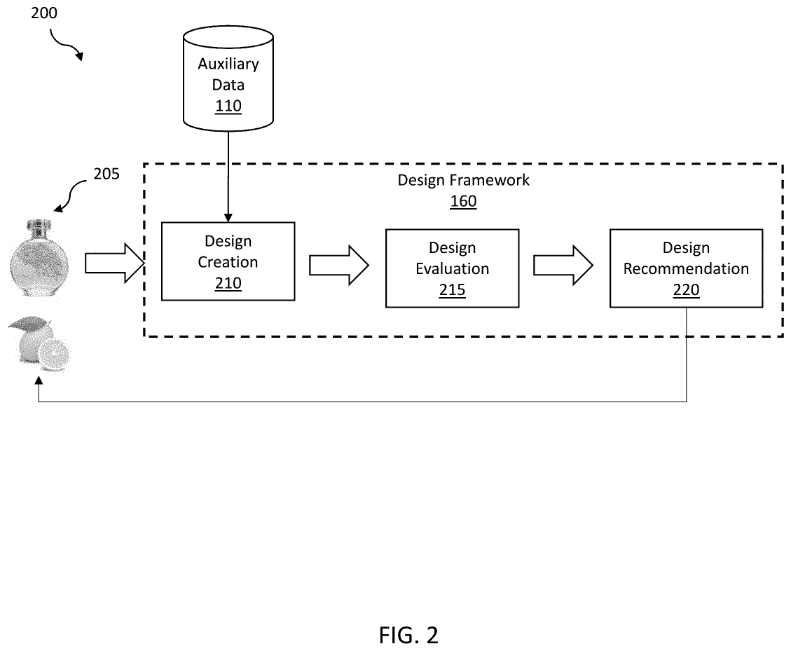

FIG. 2 is a block diagram representing an example of how the ML-based design framework 160 can be implemented, along with an example design process 200 executed by the ML-based design framework 160 in accordance with one or more embodiments of the present invention. In some examples, a user, such as user 105 (shown in FIG. 1), provides input data 205 to the ML based design framework 160. The input data 205 can be submitted to the design framework 160 through a user interface or an artificial intelligence (AI) driven tool that aids the user 105 to upload or identify input data 205 and specify parameters or constraints for the design proposal. During the design creation phase 210 of the design process 200, the design framework 160 can utilize one or more ML techniques to generate candidate designs for the design proposal. The design framework 160 combines other sources of data, such as auxiliary data 110, for pattern and relationship discovery to use in the generation of candidate designs for the design proposal. The auxiliary data 110 includes product descriptions, cost constraints, consumer insights, historical sales data, trend data from competitors, and the like.

During the design evaluation phase 215 of the design process 200, the design framework 160 generates an evaluation of the candidate designs using multi-dimensional valuation metrics. Example valuation metrics include, but are not limited to target audience relevance, design novelty, cost, proximity to competitor offerings, trendiness, and the like.

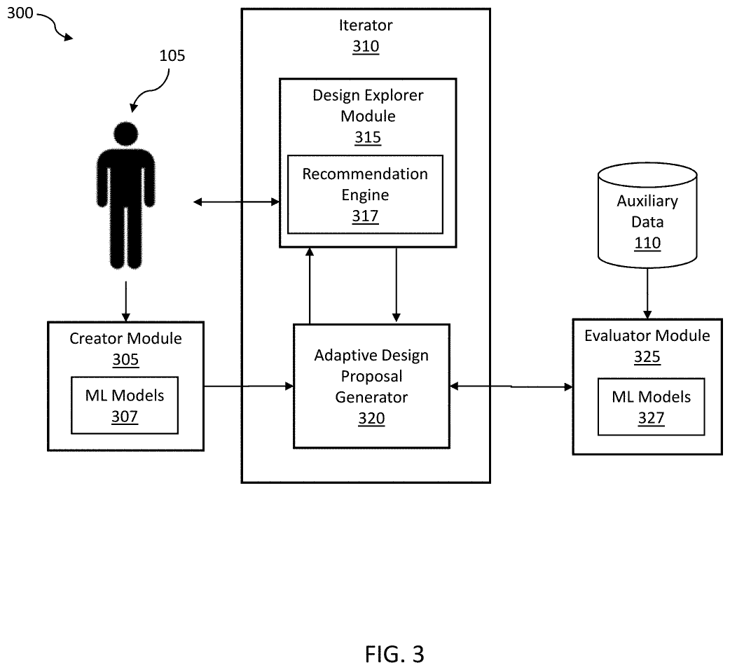

During the design recommendation phase 220, the design framework 160 uses the evaluation generated during the design evaluation phase 215 to provide a design proposal using candidate designs associated with the strongest or highest valuation metrics. The design proposal can then be presented to the user for iterative refinement (e.g., receiving feedback and updating candidate designs based on the feedback). The design process iterates through multiple rounds of the design process until a final design 170 (shown in FIG. 1) is identified. The components of the design framework 160 that implements the design process 200 are further described in FIG. 3.

Now referring to FIG. 3, a schematic hybrid data flow/block diagram illustrating a package design process 300 using a ML based design framework is depicted in accordance with one or more embodiments of the present invention. A user 105, such as a designer, can interact with a creator module 305 of the design framework to provide input data 205 (shown in FIG. 2) and additional information to generate a candidate design or a set of candidate designs for a design proposal for a package design. The creator module 305 is used for design realization and modification. The creator module 305 generates new candidate designs based on the input data 205 and any constraints or conditions provided by the user 105. The candidate designs are images generated by one or more ML models 307 and are to be used in the design proposal.

The ML models 307 utilized by the creator module 305 can be deep, multi-layer artificial neural networks. Examples of ML models 307 used by the creator module 305 include, but are not limited to a generative adversarial network (GAN), a conditional generative adversarial network (cGAN), an auto-encoder, a variational auto-encoder (VAEs), a conditional VAE (cVAE), or the like. The ML models 307 learn how to model and generate new designs using a set of existing designs. Conditional variants take additional inputs that constrain the generation (e.g., generate bottles of a specific color that is specified in the input data 205). The creator module 305 can also use computer graphics techniques to aid in the generation of candidate designs. For example, the creator module 305 can use shape morphing, such as mesh morphing or image morphing to generate and/or refine a candidate design. Mesh morphing involves creating a mesh from triangulation and optimizing the conversion of one mesh to another. The ML models 307 can use a set of designs for the generative model to learn the design space for the design proposal. The output is the trained model, which then can output candidate designs sampled from the design space. If conditional models are used, additional inputs could be the design sketch or outline, some specific design details (e.g., color, size, material, etc.), style inspiration images, etc. The creator module 305 transmits the candidate designs to the adaptive design proposal generator 320 of the iterator 310.

The creator module 305 transmits the candidate designs to the adaptive design proposal generator 320 of the iterator 310. The iterator 310 includes a design explorer module 315 and/or an adaptive design proposal generator 320 and facilitates the iterative design process for package design. In response to receiving the candidate designs from the creator module 305, the adaptive design proposal generator 320 can communicate with the evaluator module 325 to evaluate the candidate designs generated by the creator module 305. The evaluator module 325 can use one or more ML models 327 to evaluate the candidate designs. Examples of the ML models 327 used by the evaluation module 325 include, but are not limited to a support-vector machine, gradient boosting, random forest, and deep learning such as neural networks. The ML models 327 can be multi-layer neural networks. The ML model 327 can be a convolutional neural network (CNN) for any image data. The evaluation module 325 can utilize multi-task learning and transfer learning to leverage learning across diverse cases due to limited data for a particular case.

Inputs of the ML model 327 are candidate designs generated by the creator module 305. Additional inputs can include data associated with design modalities that the user wishes to predict, such as the design and sales per region or customer group, consumer testing scores per customer group, or cost per component. Such data is accessed or obtained from one or more data sources, such as the auxiliary data 110. The evaluator module 325 can utilize different techniques to generate outputs for particular elements of the design. For example, for evaluating the shape of a candidate design, the outputs of a pre-trained image classifier (e.g., deep learning model) are used to distinguish different objects. The evaluation module 325 generates an evaluation of the candidate designs that include scores along the different dimensions or metrics evaluated. The scores of the evaluation can be used by the adaptive design proposal generator 320 to modify, update, or otherwise alter the design proposal to identify or select candidate designs that are more likely to succeed. In some examples, the adaptive design proposal generator 320 can compare the scores for each of the candidate designs from the evaluation to one or more thresholds. If the scores do not meet or exceed the threshold, the candidate design can be removed from the design proposal or altered and reevaluated by the evaluator module 325. The candidate design can be included in the design proposal if its associated score meets or exceeds the threshold.

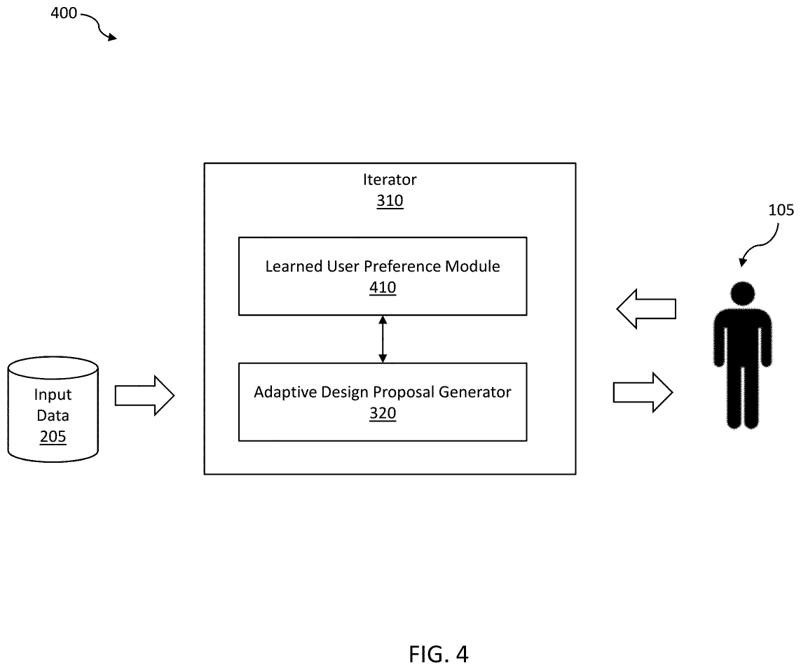

The adaptive design proposal generator 320 can update and finalize the design proposal and transmit the design proposal to the recommendation engine 317 of the design explorer module 315. The recommendation engine 317 can process the design proposal to identify a subset from the candidate designs in a recommendation for the designated reviewers. The design proposal can include the recommendation as well as the additional candidate designs to present to one or more designated reviewers (e.g., users identified to participate in the design process and provide feedback and approval). The designated reviewers can include the user that initiated the design process using the creator module 305 or any user identified by the user, organizational chart, or the like. In some example embodiments, the iterator 310 can include techniques for learning preferences of the designated reviewers and incorporating their preferences in the design process. The methods and systems directed to utilizing learned user preferences in the process for package design are further discussed in FIG. 4 below.

The design proposal can include the different metrics and/or scores received from the evaluator module 325 and that are associated with the identified candidate designs. The design proposal, which includes the recommendation generated by the recommendation engine 317, can be presented to the designated reviewers through a user interface provided by the design explorer module 315. The designated reviewers can review the recommendation and/or the candidate designs of the design proposal and provide feedback to the design explorer module 315. The feedback can be transmitted to the adaptive design proposal generator 320 to update, modify, refine, or otherwise alter the design proposal. The updated design proposal that incorporates the feedback received from the designated reviewers can be processed by the design framework 160 in an iterative process that includes evaluation by the evaluator module 325 and presentation of an updated design proposal and updated recommendation to the users 105 (e.g., designated reviewers) by the design explorer module 315. An updated design proposal can include updated and/or replacement candidate designs in response to the feedback received from the designated reviewers and/or based on the user preference profiles associated with the designated reviewers.

The iterative process of receiving feedback from users and updating the design proposal to include modified or replacement candidate designs can continue until approval of a candidate design or a set of candidate designs is received from the users 105. For example, in some examples, approval can be required from the user that initiated the design process while other examples can require approval from all designated reviewers before identifying and finalizing a candidate design or a set of candidate designs of the design proposal as a final design/design set. The adaptive design proposal generator 320 can generate a final design 170 upon receiving an appropriate level of approval from one or more users 105. The final design 170 (shown in FIG. 1) can include a finalized package design. In some examples, the adaptive design proposal generator 320 can produce a plan for production that includes at least one of a vendor, a price list, and/or a timeline for production of the final design 170. In some examples, the adaptive design proposal generator 320 can generate a report that includes an image of the final design 170 as well as any metrics or valuations used to designate the final design. The final design 170, report, and/or plan for production can be transmitted to one or more designated reviewers of the design process. In some examples, the candidate designs that were not selected can be added to a datastore of existing designs and/or the auxiliary data 110. The unused candidate designs can be used to train future ML models or may be used in future processes for design package prototyping.

FIG. 4 is a schematic hybrid data flow/block diagram illustrating a data flow 400 for interactive preference learning using a machine learning based design framework in accordance with one or more embodiments of the present invention. In some examples, the iterator 310 of the design framework 160 (shown in FIG. 1) includes a learned user preference module 410 for rapidly learning user preferences of users that interact with the design framework. In some examples, the learned user preference module 410 can use one or more ML models to detect and/or identify user preferences from input data 205 (shown in FIG. 2), feedback provided by users through their use of the design framework 160 (e.g., designated reviewers), or other interactions of the user with the design framework 160 (shown in FIG. 1). In some examples, the ML models of the learned user preference module 410 can identify current user preferences and/or a current specific design goal for a design proposal as well as overall user preferences based on previous interactions by the user with the design framework 160.

In some examples, the ML models of the learned user preference module 410 can identify and/or learn the preferences of a user based on their selection of candidate designs of a design proposal and/or any type of feedback they provide for the candidate design. Thus, the ML models are able to learn and/or identify the current design goal or preference of the user 105 for the current design proposal. Based on the information generated by the ML models of the learned user preference module 410, the adaptive design proposal generator 320 updates or adapts its recommendations to reflect what the user is currently looking for (e.g., current design goal) without the user having to explicitly identify specific characteristics or properties of the design candidates. The preferences and design goals identified by the ML models are important because the user 105 may not be able to clearly define or articulate what they are looking for in a design proposal, but the ML models can identify, based on the users behavior and interactions with the design framework 160, characteristics, trends, and/or preferences of candidate designs that the users are more likely to approve.

A user preference profile associated with the user 105 (e.g., designated reviewer) is generated and/or updated using the detected preferences based on the interactions of the user 105 with the design framework 160. The user preference profile associated with the user 105 can include general user preferences associated with the user 105 as well as current preferences and design goals for a specific or current design proposal. The user preference profile can be used by the adaptive design proposal generator 320 to update a design proposal to include new design candidates selected to reflect the user preferences and/or the current design goals of the identified designated reviewer.

In some example embodiments, the user 105 (e.g., designated reviewer) may iteratively interact with the design framework and continue to provide feedback for the updated design proposal. In response to each interaction of the designated reviewer with the design framework and the updated design proposal, the ML models of the learned user preference module 410 are applied to the feedback and/or interactions of the user to identify or learn user preferences and design goals. The input generated by the ML models are used to update the user preference profiles of the respective designated reviewers. Each of the user preference profiles are used by the adaptive design proposal generator 320 to modify or select new design candidates to update the design proposal. The learned user preference module 410 continuously applies ML models to the iterative interactions of the designated reviewer with the design proposal and design framework throughout the design process, thus enabling the adaptive design proposal generator 320 to provide improved recommendations that include new design candidates that better match the preferences of the designated reviewer involved in the design process.

In some example embodiments, in response to the iterator 310 identifying one or more users (e.g., designated reviewers) associated with the design proposal, the learned user preference module 410 can communicate with the adaptive design proposal generator 320 to update the design proposal to include new candidate designs or modified candidate designs that reflect or are based on user preferences identified and stored in the user preference profile associated with the identified users. The user preferences can be used to update, modify, and/or replace candidate designs based on the identified user preferences or design goals and can initiate re-evaluation of updated candidates designs of the updated design proposal by the evaluation module 325. Based on the feedback received from the users 105 for the design proposal and/or updated user preference profiles of the users 105, the learned user preference module 410 may use one or more ML models to identify new user preferences and update user preference profiles associated with the user 105.

In some example embodiments, the ML models of the learned user preference module 410 can learn or identify a specific design goal for each design task associated with a design proposal and/or designated reviewer. In some example embodiments, a design task associated with the design proposal can be a specific unit, job, or component of a design proposal. A design proposal is the overall plan for the design and production of a packaging for a product (e.g., blueprint of the packaging, which can include identification of materials, design, cost associated with production, etc.). The design proposal includes one or more proposed candidate designs that are identified as possibilities as designs for the product packaging. In some examples, if the design task for a design proposal is to design a new package for the release of a new fragrance, the ML models can determine and identify, based on user feedback for specific candidate designs proposed by the system, a design goal (e.g., characteristics that capture or reflect a feeling, theme, idea, or the like, that the designated reviewer is trying to capture and is reflected implicitly by their feedback for the candidate designs). The specific design goal of the designated reviewer can be limited to a session (e.g., design process for a specific design task). The learned user preference module 410 can learn the user preferences of the designated reviewer for the design goal of the design task of the design proposal and adapt recommendations and make updates to the design proposal based on the design goal for the session. In some examples, while the designated reviewer is interacting with the design framework 160 for the current design goal for the session, each time they give feedback, the design framework (e.g., learned user preference module 410) updates the ML model to identify the user preferences of the designated reviewer for the session. The ML model can map a design candidate as input to a prediction of the probability the designated reviewer will approve of the newly recommended design candidate.

The learned user preference module 410 can automatically learn the preferences and design goals of a designated reviewer for a design task based on the feedback and additional data from the designated reviewer. Thus, the learned user preference module 410 learns the designated reviewer's current design goal through the interactive and iterative feedback provided by the designated reviewer throughout the design process for a design task without the designated reviewer having to manually or explicitly having to define exactly criteria for their design goals. Rather, the current design goal for the design task is learned by the ML models of the learned user preference module 410 applied to the interactions of the designated reviewer with the design framework 160 (e.g., via feedback provided by liking design candidates, providing comments, requesting modifications to design candidates, or the like).

An example of an ML model used by the learned user preference module 410 includes transfer learning. For each design modality of interest (e.g., image, aesthetics, color, shape, consumer appeal amongst different groups, etc.), an auto-encoder or pre-trained network from an evaluator or a similar predictive deep learning model (e.g., for predicting things about the design such as sales or what class it is) is used to encode that aspect of the design as a low-dimensional vector. Using a pre-trained evaluator, the model uses the output from high layers in the network (e.g., close to the prediction output) to get the encoded representation of the design for that modality. Learning the user preference model in each case can proceed in the lower-dimensional embedding space that already captures the high-level concepts of the design related to that modality, and so is much more efficient when learning what the user wants in the given session.

An example of an ML model used by the learned user preference module 410 includes reinforcement learning or multi-armed bandit models which include using boot-strap sampling to maintain a distribution over learned user preference models and the Thompson sampling approach to balance exploration and exploitation when learning what the user is interested. Another example of an ML model used by the learned user preference module 410 includes a K-Nearest neighbor search and retrieval model to efficiently find most similar or matching designs. The learned user preference module 410 can use any machine learning model, including but not limited to, support vector machines (SVMs), boosting, random forest, deep learning/neural nets, or the like for learning the user preferences from modality encodings. The learned user preference module 410 can also use incremental and online learning models to identify user preferences.

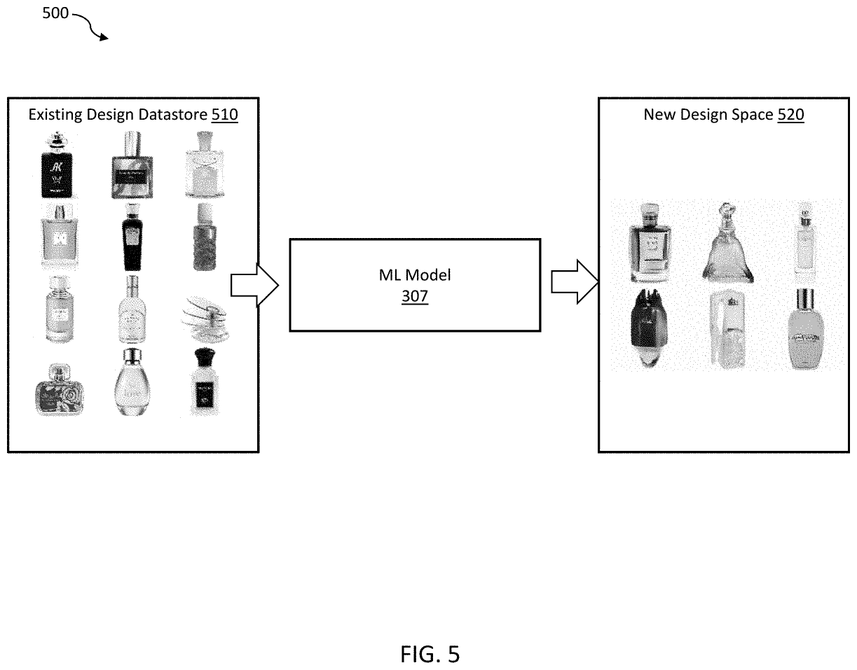

Now referring to FIG. 5, an illustrative example for design space generation by a machine learning based design framework is depicted in accordance with one or more embodiments of the present invention. In some examples, the creator module 305 of the design framework 160 (shown in FIG. 1) identifies an existing design datastore 510 to use for a design proposal. The creator module 305 (shown in FIG. 3) receives input data 205 (shown in FIG. 3) from a user 105 (shown in FIG. 1) through a user interface or AI-driven tools. The creator module 305 accesses the existing design datastore 510 to use for initial generation of the design proposal. In some examples, the existing design datastore 510 is a datastore that is stored locally to the creator module 305 or remotely in, for example, a cloud computing environment. A specific existing design datastore or designs from the design datastore can be designated by or through the input data or selected manually or dynamically using the AI-driven tools of the creator module 305. The existing design datastore 510 can be organized by industry (e.g., food and beverage, makeup, etc.), type of package design (e.g., boxes, bottles, containers, etc.), size, or any other type of metric.

One or more ML models 307 (shown in FIG. 3) can be used to generate a design space for the design proposal. The ML models 307 learn from a set of examples (e.g., existing designs such as data in an existing design datastore 510) of how to model and generate new designs. Conditional variants take additional inputs that constrain the generation of the candidate designs (e.g., generate bottles of a specific color that is input).

In some examples, the ML model 307 receives a set of existing designs as basic input. The existing designs from the existing design datastore 510 are used, for example, by a generative model to learn the design space. The output of the ML model 307 is a trained model, which can output a new design space 520 for the design proposal that includes newly generated random designs sampled from the design space. If conditional models are used, additional input data, such as a design sketch or outline, some specific design details (e.g., color, material type, etc.), style inspiration images, or the like, can be used to generate the random designs. The ML model 307 can, for example, take a random sample from the existing design datastore 510 and use the input data received from the user 105 to generate the new designs in a new design space 520 to be used for the design proposal.

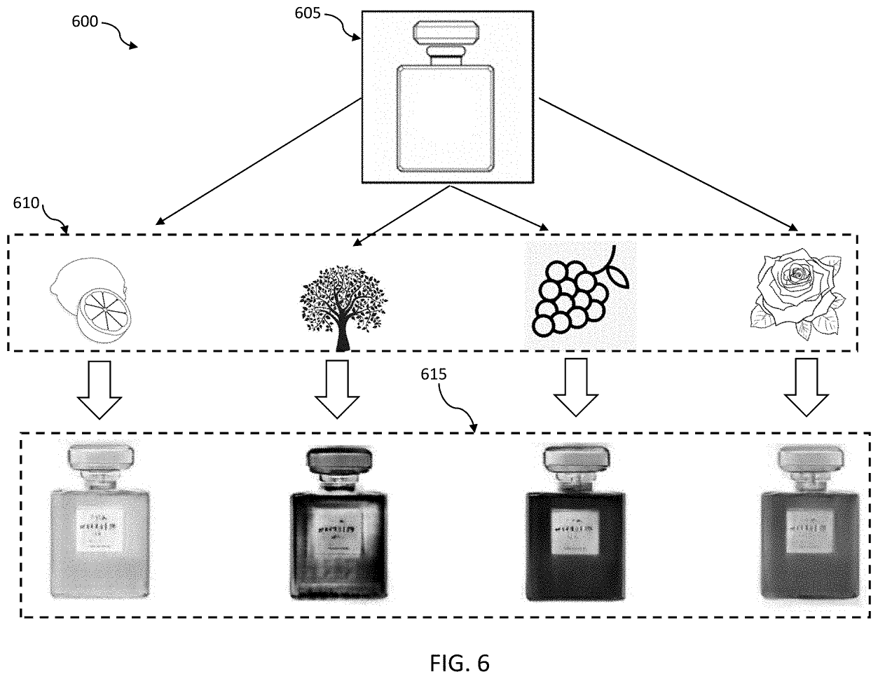

FIG. 6 depicts an illustrative example 600 for rapid prototyping of package designs by a machine learning based design framework in accordance with one or more embodiments of the present invention. In one example, the creator module 305 (shown in FIG. 3) uses ML models 307 (shown in FIG. 3) or computer graphics techniques for rapid prototyping of package designs. For example, the creator module 305 receives a design sketch 605 of a bottle as input data 205. The input data 205 (shown in FIG. 2) can also include design inspiration images 610 (e.g., color palette). The creator module 305 can use the input data to generate realistic candidate design images 615 to be used for the design proposal. The candidate design images 615 can be based on the design sketch 605 and the design inspiration images 610. For example, given the design inspiration image 610 of a lemon, the ML model 307 and/or computer graphics technique can use the color of the lemon of the design inspiration image 610 and the design sketch 605 to generate a candidate design image 615 of a bottle colored using the shades of the lemon. Similarly, given the design inspiration image 610 of a tree, the ML model 307 can use the different shades of green of the leaves and brown of the tree trunk of the design inspiration image 610 and the design sketch 605 to generate a candidate design image 615 of the bottle colored with greens and browns. The design inspiration image 610 of grapes can be used by the ML model and/or computer graphics techniques to color the design sketch 605 different shades of purple to generate the candidate design images 615. Likewise, the design inspiration image 610 of a rose can be used by the ML model 307 and/or computer graphics techniques, to color the design sketch 605 different shades of pink to generate a candidate design image 615.

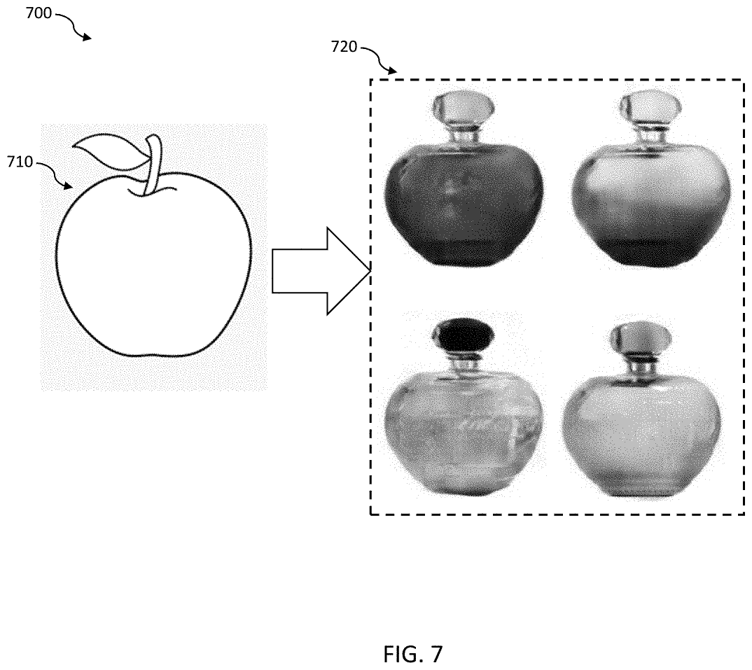

FIG. 7 depicts an illustrative example 700 for rapid prototyping of package designs by a machine learning based design framework in accordance with one or more embodiments of the present invention. In some examples, the creator module 305 (shown in FIG. 3) can utilize ML models 307 (shown in FIG. 3) and/or computer graphics techniques for rapid prototyping of package designs. The creator module 305 can receive input data 205 (shown in FIG. 2) in the form of an inspiration image 710, such as the depicted apple. The creator module 305 executes an ML model 307 and/or computer graphics techniques to generate a set 720 of realistic candidate design images shaped like an apple based on the inspiration image 710 of the apple to be used for the design proposal.

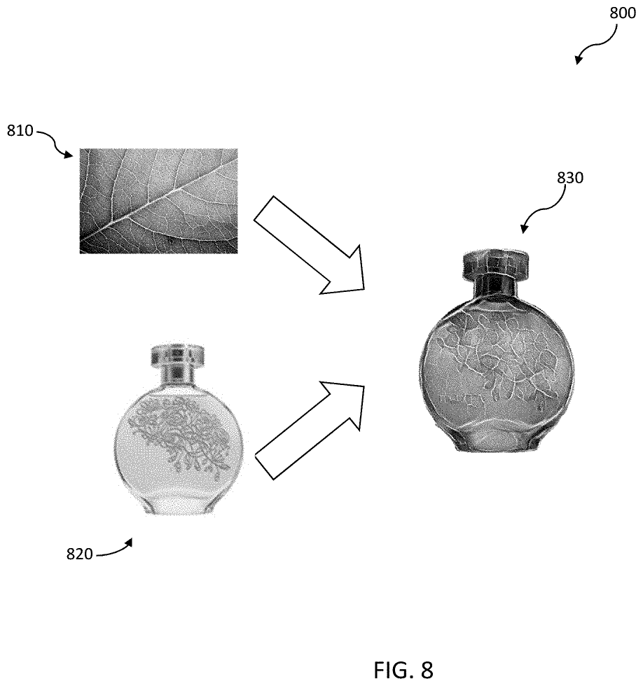

FIG. 8 depicts an illustrative example 800 for style morphing by a machine learning based design framework in accordance with one or more embodiments of the present invention. The creator module 305 (shown in FIG. 3) can utilize ML models 307 (shown in FIG. 3) and/or computer graphics techniques for style morphing for package designs. For example, an inspiration image 810, such as the green leaf depicted and a design image 820 depicting the initial bottle shape can be submitted to the creator module 305 as input data 205 (shown in FIG. 2). The design image 820 depicts a bottle with flowers that is pink. The creator module 305 can morph the style of the design image 810 using an ML model 307 and/or computer graphics technique to generate a candidate design image 830 with the initial bottle shape of the design image 820 but with stylistic changes, such as the color and the veins from the inspiration image 810 being incorporated into the candidate design image 830.

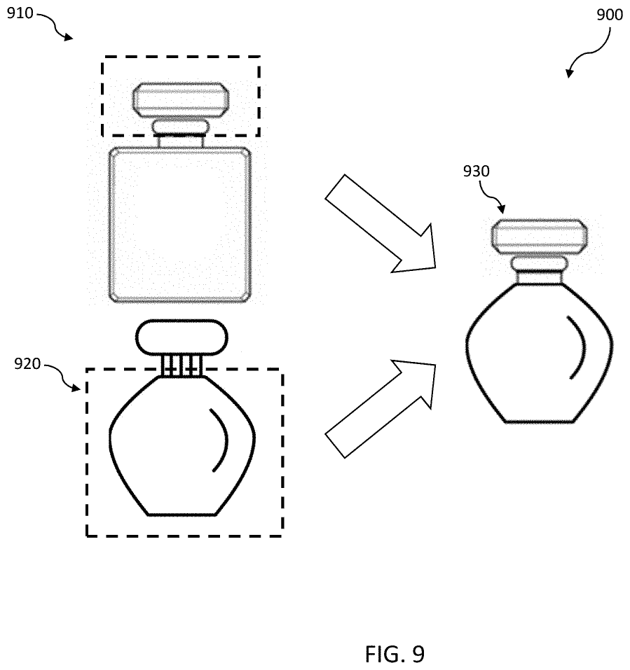

Similarly, FIG. 9 depicts an illustrative example 900 for shape fine-tuning with shape morphing by a machine learning based design framework in accordance with one or more embodiments of the present invention. Examples of computer graphic techniques can include shape morphing, such as mesh morphing and image morphing algorithms. Mesh morphing involves creating a mesh from triangulation and optimizing the conversion of one mesh to another. In the example depicted, a user 105 (shown in FIG. 1) can provide an inspiration picture 910 of bottle design and identify the lid as a point of interest. The user 105 can also provide another inspiration picture 920 of bottle design and identify the bottle shape as a point of interest. The creator module 305 (shown in FIG. 3) can morph the style of the inspiration pictures 910 and 920 using an ML model 307 (shown in FIG. 3) and/or a computer graphics technique to generate a candidate design image 830 with the lid shape of the inspiration picture 910 with the bottle shape of the inspiration picture 920.

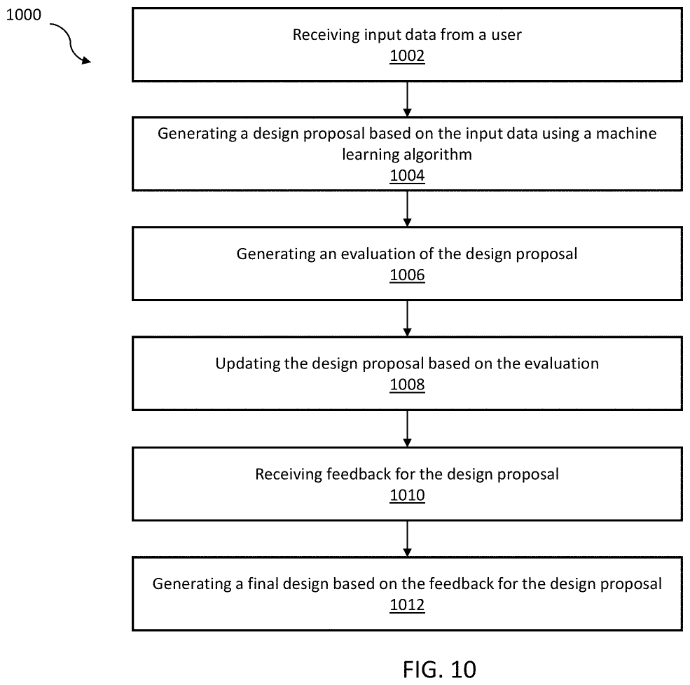

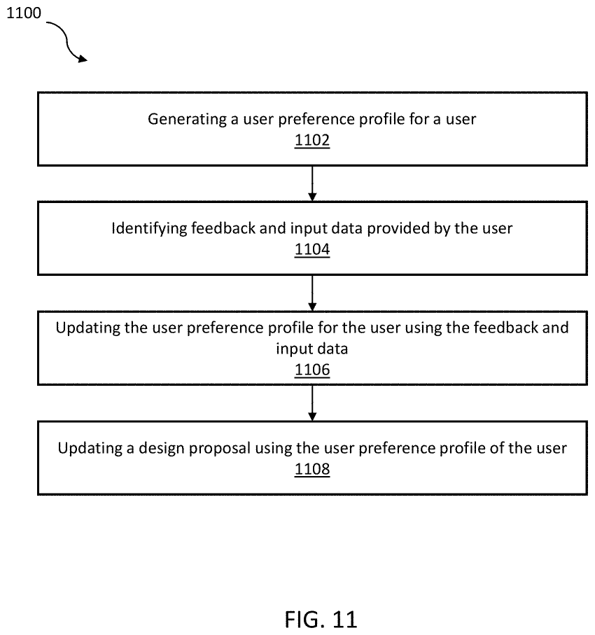

Illustrative methods in accordance with example embodiments of the disclosure and corresponding data structures (e.g., modules, units, and other such components) for performing the methods are now described. It should be noted that each operation of the methods 1000 and 1100 depicted in FIGS. 10 and 11 are performed by one or more of the modules or the like described herein. These modules can be implemented in any combination of hardware, software, and/or firmware as described herein. In certain example embodiments, one or more of these modules can be implemented, at least in part, as software and/or firmware modules that include computer-executable instructions that when executed by a processing circuit cause one or more operations to be performed. A system or device described herein as being configured to implement example embodiments can include one or more processing circuits, each of which can include one or more processing units or nodes. Computer-executable instructions can include computer-executable program code that when executed by a processing unit can cause input data contained in or referenced by the computer-executable program code to be accessed and processed to yield output data.

FIG. 10 is a flow diagram of an example computer-implemented method 1000 for package design generation using a machine learning based design framework for package design. The steps shown in FIG. 10 can be performed by any suitable computer-executable code and/or computing system. In one example, each of the steps shown in FIG. 10 can represent an algorithm whose structure includes and/or is represented by multiple sub-steps, examples of which will be provided in greater detail below.

As illustrated in FIG. 10, at step 1002 one or more of the systems described herein receives input data from a user. The systems described herein can perform step 1002 in any suitable manner. For example, the creator module 305 of an ML based design framework 160 receives input data from a user 105. As discussed herein, the input data 205 can be any type of data uploaded by the user 105 or obtained by a tool of the creator module 305. Examples of the input data 205 can include, a set of keywords, an existing design, a video, or a report. In some examples, the user 105 can identify a location of input data 205, such as a URL, location of a datastore storing the input data, or the like. Additionally, the creator module 305 can receive additional information from the user 105, such as constraints or conditions to be used to generate candidate designs for the design proposal.

At step 1004, one or more of the systems described herein generates a design proposal based on the input data using a machine learning model. The systems described herein can perform step 1004 in any suitable manner. For example, the creator module 305 can generate a set of candidate designs for a design proposal based on the received input data 205. The creator module 305 generates one or more candidate designs based on the input data 205 and any constraints or conditions received. The candidate designs are generated using one or more ML models 307 of the creator module 305. The creator module 305 transmits the candidate designs to the adaptive design proposal generator 320. In response to receiving the candidate designs from the creator module 305, the adaptive design proposal generator 320 can generate a design proposal based on the candidate designs. The adaptive design proposal generator 320 can transmit the candidate designs to the evaluator module 325.

At step 1006, one or more of the systems described herein generating an evaluation of the design proposal. The systems described herein can perform step 1006 in any suitable manner. For example, the evaluation module 325 can receive one or more candidate designs generated by the creator module 305 from the adaptive design proposal generator 320. The evaluator module 325 can also receive metrics identified by the 105 to evaluate the candidate designs. The evaluator module 325 can generate an evaluation based on the candidate designs and the identified metrics using one or more ML models 327. The ML models 327 used to evaluate the candidate designs can obtain auxiliary data 110 to use in generating the evaluation for the candidates designs. The evaluation of the candidate designs can be transmitted or communicated to the adaptive design proposal generator 320.

At step 1008, one or more of the systems described herein updating the design proposal based on the evaluation. The systems described herein can perform step 1008 in any suitable manner. For example, the adaptive design proposal generator 320 receives the evaluation of the candidate designs from the evaluation module 325. The evaluation of the candidate designs includes scores along the different dimensions or metrics evaluated. The scores of the evaluation are used by the adaptive design proposal generator 320 to modify, update, or otherwise alter the design proposal to identify or select candidate designs that are more likely to succeed. For example, the adaptive proposal generator 320 can compare the scores for each of the candidate designs from the evaluation to one or more thresholds. If the scores do not meet or exceed the threshold, the candidate design can be removed from the design proposal or altered and reevaluated by the evaluator module 325. The candidate design can be included in the design proposal if the associated score meets or exceeds the threshold.

At step 1010, one or more of the systems described herein receiving feedback for the design proposal. The systems described herein can perform step 1010 in any suitable manner. For example, the design explorer module 315 can present the design proposal to one or more designated reviewers. In some examples, the design proposal includes a recommendation of one or more candidate designs identified by the recommendation engine 317. The recommendation can include the candidate designs, metrics used to evaluate them, and additional information to aid the designated reviewers during their review. The design explorer module 315 presents the different candidate designs and associated information (e.g., evaluation metrics, costs of production, details of the design, etc.) to the users 105 (e.g., designated reviewers) for review. In some examples, the design explorer module 315 can also present some or all of the input data 205 used by the creator module 305 to generate the candidate designs to provide additional context and guidance for the designated reviewers. The designated reviewers can provide feedback through the design explorer module 315. Examples of the type of feedback can include a selection of a set number of candidate designs, requests for modification of one or more candidate designs, requests for generation of additional candidate designs to meet additional constraints or conditions, requests for generation of additional candidate designs to meet a higher threshold requirement for a given valuation metric, or the like. The design explorer module 315 receives and transmits the feedback to the adaptive design proposal generator 320.

At step 1012, one or more of the systems described herein generating a final design based on the feedback for the design proposal. The systems described herein can perform step 1012 in any suitable manner. For example, the adaptive design proposal generator 320 receives the feedback from the designated reviewers. The adaptive design proposal generator 320 uses the feedback to update, modify, refine, or otherwise alter the design proposal. The updated design proposal that incorporates the feedback can be processed by the design framework 160 in an iterative process that includes evaluation by the evaluator module 325 and presentation of an updated design proposal and updated recommendation to the designated reviewers 105 by the design explorer module 315 until approval of a candidate design of the design proposal is received from the designated reviewers. The adaptive design proposal generator 320 can generate a final design upon receiving an appropriate level of approval from one or more users 105. The final design can include a finalized package design. In some examples, the adaptive design proposal generator 320 can produce a plan for production that includes at least one of a vendor, a price list, and a timeline for production of the final design. In some examples, the adaptive design proposal generator 320 can generate a report that includes an image of the final design as well as any metrics or valuations used to designate the final design. The final design, report, and/or plan for production can be transmitted to one or more designated reviewers of the design process.

FIG. 11 is a flow diagram of an example computer-implemented method 1100 for interactive preference learning in a machine learning based design framework for package design. The steps shown in FIG. 11 can be performed by any suitable computer-executable code and/or computing system. In one example, each of the steps shown in FIG. 11 can represent an algorithm whose structure includes and/or is represented by multiple sub-steps, examples of which will be provided in greater detail below.

As illustrated in FIG. 11, at step 1102 one or more of the systems described herein generates a user preference profile for a user. The systems described herein can perform step 1102 in any suitable manner. For example, the learned user preference module 410 can generate a user preference profile for a user. The learned user preference module 410 can identify a user that interacts with the design framework 160 and determine whether there is an existing user preference profile for the user. If not, the learned user preference module 410 generates a new user preference profile associated with the user. The learned user preference module 410 can identify or detect users 105 based on their login credentials, contact information, role in an organization, or other means of identification.

At step 1104, one or more of the systems described herein identifies feedback and input data provided by the user. The systems described herein can perform step 1104 in any suitable manner. For example, the learned user preference module 410 can detect one or more actions of the user 105 interacting with the design framework 160 and can process the action to identify feedback and/or input data provided by the user. In some examples, the learned user preference module 410 may use one or more ML models to identify patterns or data from the feedback and/or input data. In some examples, the ML models process historic data associated with the user to identify behavior or preference patterns or other preferences.

At step 1106, one or more of the systems described herein updating the user preference profile for the user using the feedback and input data. The systems described herein can perform step 1106 in any suitable manner. For example, the learned user preference module 410 can update the user preference profile using the data generated or identified by one or more ML models utilized by the learned user preference module 410.

At step 1108, one or more of the systems described herein updating a design proposal using the user preference profile of the user. The systems described herein can perform step 1108 in any suitable manner. For example, the learned user preference module 410 can detect or identify when a user is involved in creating, reviewing, or otherwise interacting with a design proposal using the design framework 160. Before the design proposal is finalize, the learned user preference module 410 communicates with the adaptive design proposal generator 320 to modify the design proposal based on the preferences associated with the user found the user preference profile. The updated design proposal can be presented to the designated users in the design process for review.

In some examples, the user preference profile of a user includes preferences for how a user interacts with the design framework 160. The design explorer module 315 can access the user preference profile of a user interacting with the design proposal and can modify the user interface presented to the user based on the preferences stored in the user preference profile.

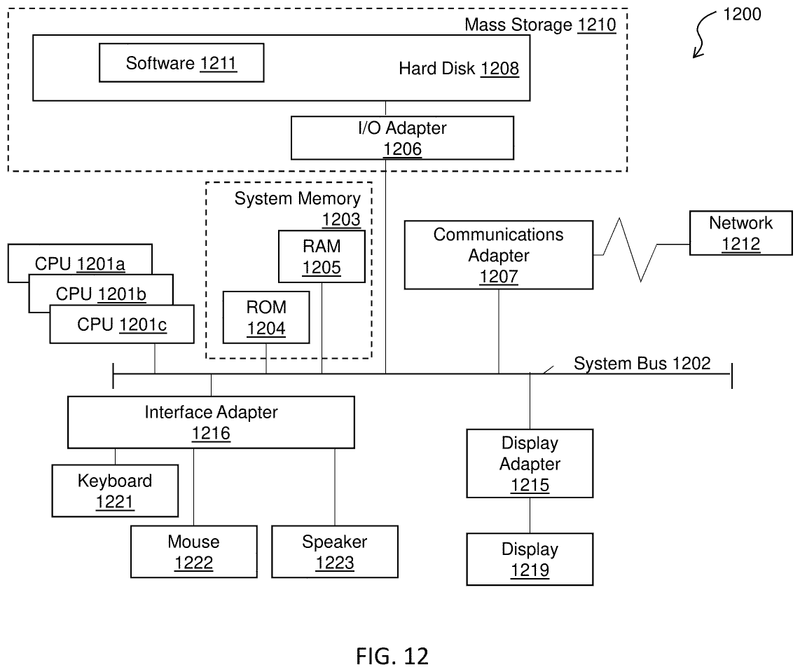

Turning now to FIG. 12, a computer system 1200 is generally shown in accordance with an embodiment of the present invention. The computer system 1200 can be an electronic, computer framework comprising and/or employing any number and combination of computing devices and networks utilizing various communication technologies, as described herein. The computer system 1200 can be easily scalable, extensible, and modular, with the ability to change to different services or reconfigure some features independently of others. The computer system 1200 may be, for example, a server, desktop computer, laptop computer, tablet computer, or smartphone. In some examples, computer system 1200 may be a cloud computing node. Computer system 1200 may be described in the general context of computer system executable instructions, such as program modules, being executed by a computer system. Generally, program modules may include routines, programs, objects, components, logic, data structures, and so on that perform particular tasks or implement particular abstract data types. Computer system 1200 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, the computer system 1200 has one or more central processing units (CPU(s)) 1201a, 1201b, 1201c, etc. (collectively or generically referred to as processor(s) 1201). The processors 1201 can be a single-core processor, multi-core processor, computing cluster, or any number of other configurations. The processors 1201, also referred to as processing circuits, are coupled via a system bus 1202 to a system memory 1203 and various other components. The system memory 1203 can include a read only memory (ROM) 1204 and a random-access memory (RAM) 1205. The ROM 1204 is coupled to the system bus 1202 and may include a basic input/output system (BIOS), which controls certain basic functions of the computer system 1200. The RAM is read-write memory coupled to the system bus 1202 for use by the processors 1201. The system memory 1203 provides temporary memory space for operations of said instructions during operation. The system memory 1203 can include random access memory (RAM), read only memory, flash memory, or any other suitable memory systems.

The computer system 1200 comprises an input/output (I/O) adapter 1206 and a communications adapter 1207 coupled to the system bus 1202. The I/O adapter 1206 may be a small computer system interface (SCSI) adapter that communicates with a hard disk 1208 and/or any other similar component. The I/O adapter 1206 and the hard disk 1208 are collectively referred to herein as a mass storage 1210.

Software 1211 for execution on the computer system 1200 may be stored in the mass storage 1210. The mass storage 1210 is an example of a tangible storage medium readable by the processors 1201, where the software 1211 is stored as instructions for execution by the processors 1201 to cause the computer system 1200 to operate, such as is described herein below with respect to the various Figures. Examples of computer program product and the execution of such instruction is discussed herein in more detail. The communications adapter 1207 interconnects the system bus 1202 with a network 1212, which may be an outside network, enabling the computer system 1200 to communicate with other such systems. In one embodiment, a portion of the system memory 1203 and the mass storage 1210 collectively store an operating system, which may be any appropriate operating system, such as the z/OS or AIX operating system from IBM Corporation, to coordinate the functions of the various components shown in FIG. 12.

Additional input/output devices are shown as connected to the system bus 1202 via a display adapter 1215 and an interface adapter 1216 and. In one embodiment, the adapters 1206, 1207, 1215, and 1216 may be connected to one or more I/O buses that are connected to the system bus 1202 via an intermediate bus bridge (not shown). A display 1219 (e.g., a screen or a display monitor) is connected to the system bus 1202 by a display adapter 1215, which may include a graphics controller to improve the performance of graphics intensive applications and a video controller. A keyboard 1221, a mouse 1222, a speaker 1223, etc. can be interconnected to the system bus 1202 via the interface adapter 1216, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 12, the computer system 1200 includes processing capability in the form of the processors 1201, and, storage capability including the system memory 1203 and the mass storage 1210, input means such as the keyboard 1221 and the mouse 1222, and output capability including the speaker 1223 and the display 1219.

In some embodiments, the communications adapter 1207 can transmit data using any suitable interface or protocol, such as the internet small computer system interface, among others. The network 1212 may be a cellular network, a radio network, a wide area network (WAN), a local area network (LAN), or the Internet, among others. An external computing device may connect to the computer system 1200 through the network 1212. In some examples, an external computing device may be an external webserver or a cloud computing node.

It is to be understood that the block diagram of FIG. 12 is not intended to indicate that the computer system 1200 is to include all of the components shown in FIG. 12. Rather, the computer system 1200 can include any appropriate fewer or additional components not illustrated in FIG. 12 (e.g., additional memory components, embedded controllers, modules, additional network interfaces, etc.). Further, the embodiments described herein with respect to computer system 1200 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

What is claimed is:

1. A computer-implemented method comprising:
receiving, by a processor of a computing device, input data;
generating, by the processor, a design proposal based on the input data using a machine learning model, wherein the design proposal comprises one or more candidate designs;
receiving, by the processor, feedback for the design proposal from a designated reviewer of the design proposal;
updating, by the processor, a user preference profile associated with the designated reviewer using data generated by a different machine learning model based on the feedback for the design proposal;
updating, by the processor, the design proposal to replace one of the one or more candidate designs with a new candidate design based on the user preference profile associated with the designated reviewer; and
generating, by the processor, a final design based on the design proposal.

2. The computer-implemented method of claim 1 further comprising:
generating, by the processor, an evaluation of the design proposal using auxiliary data;
updating, by the processor, the design proposal based on the evaluation; and
transmitting, by the processor, the design proposal to the designated reviewer of the design proposal.

3. The computer-implemented method of claim 1, wherein the auxiliary data comprises at least one of a product description, consumer insight data, trend data, a cost constraint, or sales data.

4. The computer-implemented method of claim 1, wherein the machine learning model comprises at least one of a generative adversarial network (GAN), a conditional generative adversarial network (cGAN), an auto-encoder, a variational auto-encoder (VAEs), and a conditional VAE (cVAE).

5. The computer-implemented method of claim 1 further comprising generating a plan for production comprising at least one of a vendor, a price list, and a timeline for production of the final design.

6. The computer-implemented method of claim 1, wherein the input data comprises at least one of an image, an audio file, a set of keywords, an existing design, a video, or a report.

7. The computer-implemented method of claim 1, wherein the one or more candidate designs comprises an image.

8. A system comprising:
a memory; and
a processor coupled with the memory, the processor configured to perform a method comprising:
receiving input data;
generating a design proposal based on the input data using a machine learning model, wherein the design proposal comprises one or more candidate designs;
receiving feedback for the design proposal from a designated reviewer of the design proposal;
updating a user preference profile associated with the designated reviewer using data generated by a different machine learning model based on the feedback for the design proposal;
updating the design proposal to replace one of the one or more candidate designs with a new candidate design based on the user preference profile associated with the designated reviewer; and
generating a final design based on the feedback for the design proposal.

9. The system of claim 8, wherein the method performed by the processor further comprises:
generating an evaluation of the design proposal using auxiliary data;
updating the design proposal based on the evaluation; and
transmitting the design proposal to the designated reviewer of the design proposal.

10. The system of claim 8, wherein the auxiliary data comprises at least one of a product description, consumer insight data, trend data, a cost constraint, or sales data.

11. The system of claim 8, wherein the machine learning model comprises at least one of a generative adversarial network (GAN), a conditional generative adversarial network (cGAN), an auto-encoder, a variational auto-encoder (VAE), and a conditional VAE (cVAE).

12. The system of claim 8, wherein the method performed by the processor further comprises generating a plan for production comprising at least one of a vendor, a price list, and a timeline for production of the final design.

13. The system of claim 8, wherein the input data comprises at least one of an image, an audio file, a set of keywords, an existing design, a video, or a report.

14. The system of claim 8, wherein the one or more candidate designs comprises an image.

15. A computer program product comprising a computer-readable storage media having computer-executable instructions stored thereupon, which when executed by a processor cause the processor to perform a method comprising:
receiving input data;
generating a design proposal based on the input data using a machine learning model, wherein the design proposal comprises one or more candidate designs;
receiving feedback for the design proposal from a designated reviewer of the design proposal;
updating a user preference profile associated with the designated reviewer using data generated by a different machine learning model based on the feedback for the design proposal;
updating the design proposal to replace one of the one or more candidate designs with a new candidate designs based on an updated user preference profile associated with the designated reviewer; and
generating a final design based on the design proposal.

16. The computer program product of claim 15, wherein the method performed by the processor further comprises:
generating an evaluation of the design proposal using auxiliary data;
updating the design proposal based on the evaluation; and
transmitting the design proposal to the designated reviewer of the design proposal.

17. The computer program product of claim 15, wherein the auxiliary data comprises at least one of a product description, consumer insight data, trend data, a cost constraint, or sales data.

18. The computer program product of claim 15, wherein the machine learning model comprises at least one of a generative adversarial network (GAN), a conditional generative adversarial network (cGAN), an auto-encoder, a variational auto-encoder (VAEs), and a conditional VAE (cVAE).

19. The computer program product of claim 15, wherein the method performed by the processor further comprises generating a plan for production comprising at least one of a vendor, a price list, and a timeline for production of the final design.

20. The computer program product of claim 15, wherein the input data comprises at least one of an image, an audio file, a set of keywords, an existing design, a video, or a report.
